(19) United States
(12) Patent Application Publication
(10) Pub. No.: US 2015/0376348 A1
(43) Pub. Date: Dec. 31, 2015

(54) Rubber Compositions Including Cellulose Esters And Inorganic Oxides

(71) Applicant: Bridgestone Americas Tire Operations, LLC, Nashville, TN (US)

(72) Inventors: Natalie V. Weingart, Canton, OH (US); Amy M. Randall, Akron, OH (US)

(21) Appl. No.: 14/750,023

(22) Filed: Jun. 25, 2015

Related U.S. Application Data
(60) Provisional application No. 62/019,078, filed on Jun. 30, 2014.

(51) Int. Cl. C08J 3/24; C08K 9/00

(52) U.S. Cl. CPC C08J 3/24; C08K 9/00; C08J 2309/06; C08J 2407/00; C08J 2401/10

(57) ABSTRACT

A process for preparing a vulcanizable composition, the process comprising mixing a vulcanizable rubber, a chemically-treated inorganic oxide, and a cellulose ester to prepare an initial masterbatch, introducing a rubber curative to the masterbatch, and mixing the masterbatch and curative to form the vulcanizable composition.

### FIELD OF THE INVENTION

Embodiments of the present invention are directed toward tire components and vulcanizable compositions used to prepare tire components that include cellulose esters and inorganic oxides, as well as methods for preparing these corporations. In one or more embodiments, the inorganic oxides are introduced to the vulcanizable compositions as chemically treated inorganic oxide.

### BACKGROUND OF THE INVENTION

In the art of making tires, the mechanical and dynamic properties of the rubber components, such as the treads, have been manipulated through the use of various filler materials. The ability to disperse these filler materials into the rubber has historically been a challenge, and various techniques have been employed to achieve adequate filler dispersion. Additionally, interaction between the filler particles and the rubber is often desired. For example, highly dispersed filler and/or polymer-filler interactions often give rise to tire components characterized by high rebound and low hysteretic energy loss.

While the tire industry has historically employed carbon black as a reinforcing filler, the use of inorganic oxides, such as silica, has increased over the past couple of decades. These fillers are believed to be advantageous in several respects, especially in the tread, where improved wear and good traction are desired. While advantageous, inorganic oxide fillers present special challenges because they do not readily interact with the rubber. As a result, coupling agents have been employed to chemically link the inorganic particles to the rubber. This reaction, however, must be carefully conducted so as to not interfere with other reactions and/or interactions taking place during the preparation of the vulcanizable composition.

In an effort to alleviate mixing problems associated with highly-filled rubber compositions, the use of cellulose esters has been proposed. It is believed that these materials act as processing aids during rubber mixing since they melt and flow at elastomer processing temperatures, and then upon cooling, they solidify and act as reinforcing filler particles.

While the use of cellulose esters may therefore be advantageous, the cellulose esters are nonetheless reactive compounds that have the potential to interfere with the otherwise delicate balance of reactions that take place during rubber mixing and the preparation of vulcanizable compositions. There is, therefore, a need to develop techniques for properly incorporating cellulose esters into vulcanizable compositions without deleteriously impacting the vulcanizable compositions or vulcanizates that derive from these compositions.

### SUMMARY OF THE INVENTION

One or more embodiments of the present invention provide a process for preparing a vulcanizable composition, the process comprising mixing a vulcanizable rubber, a chemically-treated inorganic oxide, and a cellulose ester to prepare an initial masterbatch, introducing a rubber curative to the masterbatch, and mixing the masterbatch and curative to form the vulcanizable composition.

Still other embodiments of the present invention provide a rubber vulcanizate prepared by mixing a vulcanizable rubber, a chemically-treated inorganic oxide, and a cellulose ester to prepare an initial masterbatch, introducing a rubber curative to the masterbatch, and mixing the masterbatch and curative to form the vulcanizable composition.

### DETAILED DESCRIPTION OF ILLUSTRATIVE EMBODIMENTS

### Introduction

Embodiments of the present invention are based, at least in part, on the discovery of improved tire components that include a cellulose ester and an inorganic oxide filler. The tire components are constructed from vulcanizable compositions that are prepared by mixing a vulcanizable rubber, a chemically-treated inorganic oxide, and a cellulose ester. While the prior art contemplates the use of inorganic oxides and cellulose esters in tire components, it has been discovered that the presence of the cellulose esters has a deleterious impact on the coupling of the inorganic oxide to the rubber. Specifically, it is believed that the cellulose esters interfere with the reaction between an inorganic oxide and the coupling agents that are used to couple the inorganic oxide to the rubber. The present invention, which employs chemically-treated inorganic oxide, unexpectedly overcomes the problems observed when the inorganic oxide, cellulose esters, and coupling agents are individually combined and mixed to form vulcanizable compositions. As a result, technologically useful tire components are advantageously produced.

### Process Overview

In one or more embodiments, vulcanizable compositions are prepared by mixing a vulcanizable rubber, a cellulose ester, and a chemically-treated inorganic oxide to form a masterbatch, and then a curative is subsequently added to the masterbatch. The preparation of the masterbatch may take place using one or more sub-mixing steps where, for example, one or more ingredients may be added to the composition sequentially after an initial mixture is prepared by mixing two or more ingredients. Also, using conventional technology, additional ingredients can be added in the preparation of the masterbatch such as, but not limited to, additional fillers, processing oils, processing aids, and antidegradants.

### Mixing Conditions

In particular embodiments, a vulcanizable composition is prepared by first mixing a vulcanizable rubber, a chemically-treated inorganic oxide, and a cellulose ester at a temperature of from about 140 to about 180, or in other embodiments from about 150 to about 170° C. Following the initial mixing, the composition (i.e., masterbatch) is cooled to a temperature of less than 100° C., or in other embodiments less than 80° C., and a curative is added. Mixing is continued at a temperature of from about 90 to about 110, or in other embodiments from about 95 to about 105° C., to prepare the final vulcanizable composition.

### Amounts

In one or more embodiments, the vulcanizable compositions are prepared by introducing sufficient rubber to prepare a vulcanizable composition having from about 40 to about 70, in other embodiments from about 45 to about 65, and in other embodiments from about 50 to about 60 weight percent vulcanizable rubber based upon the entire weight of the vulcanizable composition.

In one or more embodiments, the vulcanizable compositions are prepared by introducing sufficient cellulose ester to prepare a vulcanizable composition having from about 1 to about 15, in other embodiments from about 2 to about 10, and in other embodiments from about 3 to about 8 parts by weight cellulose ester per 100 parts by weight rubber.

In one or more embodiments, the vulcanizable compositions are prepared by introducing sufficient chemically-treated inorganic oxide to prepare a vulcanizable composition having from about 1 to about 90, in other embodiments from about 20 to about 80, and in other embodiments from about 45 to about 65 parts by weight chemically-treated inorganic oxide per 100 parts by weight rubber.

In one or more embodiments, the vulcanizable compositions may optionally be prepared by introducing sufficient carbon black to prepare a vulcanizable composition having from about 1 to about 90, in other embodiments from about 20 to about 80, and in other embodiments from about 45 to about 65 parts by weight carbon black per 100 parts by weight rubber. Vulcanizable Rubber

In one or more embodiments, the vulcanizable rubber, which may also be referred to as an elastomer, may include those polymers that can be vulcanized to form compositions possessing rubbery or elastomeric properties. These elastomers may include natural and synthetic rubbers. The synthetic rubbers typically derive from the polymerization of conjugated diene monomer, the copolymerization of conjugated diene monomer with other monomer such as vinyl-substituted aromatic monomer, or the copolymerization of ethylene with one or more cc-olefins and optionally one or more diene monomers.

Exemplary elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures.

### Cellulose Ester

The cellulose ester utilized in this invention can be any that is known in the art. The cellulose esters useful in the present invention can be prepared using techniques known in the art or can be commercially obtained, e.g., from Eastman Chemical Company, Kingsport, Tenn., U.S.A. Useful cellulose esters and methods for their use in rubber compositions are disclosed in U.S. Publ. Nos 2013/0150500, 2013/0150491, 2013/0150492, 2013/0150493, 2013/0150494, 2013/0150495, 2013/0150484, 2013/0150501, 2013/0131221, 2013/0150496, 2013/0150497, 2013/0150498, and 20130150499, which are incorporated herein by reference.

The cellulose esters of the present invention generally comprise repeating units of the structure:

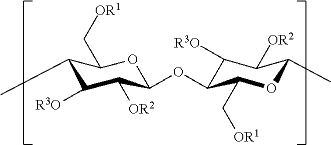

wherein R¹, R², and R³ may be selected independently from the group consisting of hydrogen or a straight chain alkanoyl having from 2 to 10 carbon atoms. For cellulose esters, the substitution level is usually expressed in terms of degree of substitution (“DS”), which is the average number of substitutents per anhydroglucose unit (“AGU”). Generally, conventional cellulose contains three hydroxyl groups per AGU that can be substituted; therefore, the DS can have a value between zero and three. Alternatively, lower molecular weight cellulose mixed esters can have a total degree of substitution ranging from about 3.08 to about 3.5. Generally, cellulose is a large polysaccharide with a degree of polymerization from 700 to 2,000 and a maximum DS of 3.0. However, as the degree of polymerization is lowered, as in low molecular weight cellulose mixed esters, the end groups of the polysaccharide backbone become relatively more significant, thereby resulting in a DS ranging from about 3.08 to about 3.5.

Because DS is a statistical mean value, a value of 1 does not assure that every AGU has a single substituent. In some cases, there can be unsubstituted AGUs, some with two substitutents, and some with three substitutents. The “total DS” is defined as the average number of substitutents per AGU. In one embodiment of the invention, the cellulose esters can have a total DS per AGU (DS/AGU) of at least about 0.5, 0.8, 1.2, 1.5, or 1.7. Additionally or alternatively, the cellulose esters can have a total DS/AGU of not more than about 3.0, 2.9, 2.8, or 2.7. The DS/AGU can also refer to a particular substituent, such as, for example, hydroxyl, acetyl, butyryl, or propionyl. For instance, a cellulose acetate can have a total DS/AGU for acetyl of about 2.0 to about 2.5, while a cellulose acetate propionate (“CAP”) and cellulose acetate butyrate (“CAB”) can have a total DS/AGU of about 1.7 to about 2.8.

The cellulose ester can be a cellulose triester or a secondary cellulose ester. Examples of cellulose triesters include, but are not limited to, cellulose triacetate, cellulose tripropionate, or cellulose tributyrate. Examples of secondary cellulose esters include cellulose acetate, cellulose acetate propionate, and cellulose acetate butyrate. These cellulose esters are described in U.S. Pat. Nos. 1,698,049; 1,683,347; 1,880,808; 1,880,560; 1,984,147, 2,129,052; and 3,617,201, which are incorporated herein by reference in their entirety to the extent they do not contradict the statements herein.

In one embodiment of the invention, the cellulose ester is selected from the group consisting of cellulose acetate, cellulose acetate propionate, cellulose acetate butyrate, cellulose triacetate, cellulose tripropionate, cellulose tributyrate, and mixtures thereof.

The degree of polymerization (“DP”) as used herein refers to the number of AGUs per molecule of cellulose ester. In one embodiment of the invention, the cellulose esters can have a DP of at least about 2, 10, 50, or 100. Additionally or alternatively, the cellulose esters can have a DP of not more than about 10,000, 8,000, 6,000, or 5,000.

In certain embodiments, the cellulose esters can have an inherent viscosity (“IV”) of at least about 0.2, 0.4, 0.6, 0.8, or 1.0 deciliters/gram as measured at a temperature of 25° C. for a 0.25 gram sample in 100 ml of a 60/40 by weight solution of phenol/tetrachloroethane. Additionally or alternatively, the cellulose esters can have an IV of not more than about 3.0, 2.5, 2.0, or 1.5 deciliters/gram as measured at a temperature of 25° C. for a 0.25 gram sample in 100 ml of a 60/40 by weight solution of phenol/tetrachloroethane.

In certain embodiments, the cellulose esters can have a falling ball viscosity of at least about 0.005, 0.01, 0.05, 0.1, 0.5, 1, or 5 pascals-second (“Pa·s”). Additionally or alternatively, the cellulose esters can have a falling ball viscosity of not more than about 50, 45, 40, 35, 30, 25, 20, or 10 Pa·s.

In certain embodiments, the cellulose esters can have a hydroxyl content of at least about 1.2, 1.4, 1.6, 1.8, or 2.0 weight percent.

In certain embodiments, the cellulose esters useful in the present invention can have a weight average molecular weight (M_{w}) of at least about 5,000, 10,000, 15,000, or 20,000 as measured by gel permeation chromatography (“GPC”). Additionally or alternatively, the cellulose esters useful in the present invention can have a weight average molecular weight (M,) of not more than about 400,000, 300,000, 250,000, 100,000, or 80,000 as measured by GPC. In another embodiment, the cellulose esters useful in the present invention can have a number average molecular weight (Mₙ) of at least about 2,000, 4,000, 6,000, or 8,000 as measured by GPC. Additionally or alternatively, the cellulose esters useful in the present invention can have a number average molecular weight (Mₙ) of not more than about 100,000, 80,000, 60,000, or 40,000 as measured by GPC.

In certain embodiments, the cellulose esters can have a glass transition temperature (“Tg”) of at least about 50° C., 55° C., 60° C., 65° C., 70° C., 75° C., or 80° C. Additionally or alternatively, the cellulose esters can have a Tg of not more than about 200° C., 190° C., 180° C., 170° C., 160° C., 150° C., 140° C., or 130° C.

In one embodiment of the present invention, the cellulose esters utilized in the elastomeric compositions have not previously been subjected to fibrillation or any other fiber-producing process. In such an embodiment, the cellulose esters are not in the form of fibrils and can be referred to as “non-fibril.”

The cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and from sources such as, for example, cotton linters, softwood pulp, hardwood pulp, corn fiber and other agricultural sources, and bacterial celluloses.

One method of producing cellulose esters is by esterification. In such a method, the cellulose is mixed with the appropriate organic acids, acid anhydrides, and catalysts and then converted to a cellulose triester. Ester hydrolysis is then performed by adding a water-acid mixture to the cellulose triester, which can be filtered to remove any gel particles or fibers. Water is added to the mixture to precipitate out the cellulose ester. The cellulose ester can be washed with water to remove reaction by-products followed by dewatering and drying.

The cellulose triesters that are hydrolyzed can have three substitutents selected independently from alkanoyls having from 2 to 10 carbon atoms. Examples of cellulose triesters include cellulose triacetate, cellulose tripropionate, and cellulose tributyrate or mixed triesters of cellulose such as cellulose acetate propionate and cellulose acetate butyrate. These cellulose triesters can be prepared by a number of methods known to those skilled in the art. For example, cellulose triesters can be prepared by heterogeneous acylation of cellulose in a mixture of carboxylic acid and anhydride in the presence of a catalyst such as H₂SO₄.

Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Inc., Kingsport, Tenn., U.S.A., typically has a DS from about 2.85 to about 2.95.

After esterification of the cellulose to the triester, part of the acyl substitutents can be removed by hydrolysis or by alcoholysis to give a secondary cellulose ester. Secondary cellulose esters can also be prepared directly with no hydrolysis by using a limiting amount of acylating reagent. This process is particularly useful when the reaction is conducted in a solvent that will dissolve cellulose.

In another embodiment of the invention, low molecular weight mixed cellulose esters can be utilized, such as those disclosed in U.S. Pat. No. 7,585,905, which is incorporated herein by reference to the extent it does not contradict the statements herein.

In one embodiment of the invention, a low molecular weight mixed cellulose ester is utilized that has the following properties: (A) a total DS/AGU of from about 3.08 to about 3.50 with the following substitutions: a DS/AGU of hydroxyl of not more than about 0.70, a DS/AGU of C3/C4 esters from about 0.80 to about 1.40, and a DS/AGU of acetyl of from about 1.20 to about 2.34; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

In another embodiment of the invention, a low molecular weight mixed cellulose ester is utilized that has the following properties: a total DS/AGU of from about 3.08 to about 3.50 with the following substitutions: a DS/AGU of hydroxyl of not more than about 0.70; a DS/AGU of C3/C4 esters from about 1.40 to about 2.45, and DS/AGU of acetyl of from about 0.20 to about 0.80; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

In yet another embodiment of the invention, a low molecular weight mixed cellulose ester is utilized that has the following properties: a total DS/AGU of from about 3.08 to about 3.50 with the following substitutions: a DS/AGU of hydroxyl of not more than about 0.70; a DS/AGU of C3/C4 esters from about 2.11 to about 2.91, and a DS/AGU of acetyl of from about 0.10 to about 0.50; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

### Chemically-Treated Inorganic Oxide

The chemically-treated inorganic oxides employed in the practice of the present invention are known as described in U.S. Pat. Nos. 6,342,560, 6,649,684, 7,569,107, 7,687,107, and 7,704,552, which are incorporated herein by reference. Also, chemically-treated inorganic oxides are commercially available under the tradenames Agilon™ 454 silica, Agilon™ 400 silica, Agilon™ and 458 Silica (PPG Industries).

In one or more embodiments, the chemically-treated inorganic oxide, which may include an amorphous or particulate inorganic oxide, may be characterized by a carbon content of greater than 1 weight percent, a sulfur content of greater than 0.1 weight percent, a Silane Conversion Index (described hereinafter) of at least 0.3 and a Standard Tensile Stress @ 300% elongation (also described hereinafter) of 7 or more can be prepared. The process described in U.S. Pat. No. 5,908,660, which is incorporated herein, may be improved and used to produce the modified filler of the present invention by utilizing a certain combination of functionalizing and hydrophobizing agents in an aqueous suspension of inorganic oxide having a pH of 2.5 or less and treating the acidic aqueous suspension of modified fillers with acid neutralizing agents to increase the pH of the suspension to a range of from 3.0 to 10.

In one or more embodiments, the functionalizing agent is a reactive chemical that can cause an inorganic oxide to be covalently bonded to the polymeric composition in which it is used. The hydrophobizing agent is a chemical that can bind to and/or be associated with an inorganic oxide to the extent that it causes a reduction in the affinity for water of the inorganic oxide while increasing the inorganic oxide's affinity for the organic polymeric composition in which it is used.

The aforementioned Standard Tensile Stress @ 300% elongation (STS@300%) of at least 7 or greater indicates improved reinforcement of the rubber composition. Improved reinforcement translates into an improvement in the mechanical durability of the product which is evidenced by increased tear strength, hardness and abrasion resistance. In addition to the improved properties, the modified filler has the benefit of requiring less time and energy to get incorporated into the polymeric composition.

In one or more embodiments, the chemically-treated inorganic oxide is characterized by a carbon content of greater than 1 weight percent, a mercapto content of greater than 0.15 weight percent, a Silane Conversion Index (described hereinafter) of at least 0.3, and a Standard Reinforcement Index (also described hereinafter) of 4 or more can be prepared. The process described in U.S. Pat. No. 5,908,660 may be improved and used to produce the modified filler of the present invention by utilizing a certain combination of functionalizing and hydrophobizing agents in an aqueous suspension of inorganic oxide having a pH of 2.5 or less and treating the acidic aqueous suspension of modified fillers with acid neutralizing agents to increase the pH of the suspension to a range of from 3.0 to 10.

The aforementioned Standard Reinforcement Index (SRI) of at least 4 or greater indicates a modification of the interaction or bonding between the components of the filler-polymer composition. Specifically, there is a stronger interaction between the filler and polymer and/or the polymer and polymer than usually present for a given amount of interaction between filler and filler. Alternatively stated, there is a weaker interaction between the filler and filler than usually present for a given amount of interaction between filler and polymer and/or polymer and polymer. Appropriate modifications of these interactions in a rubber composition have been reported to result in better tire performance, e.g., improved treadwear life, lower rolling resistance, better traction on snow and lower noise generation. In addition to the improved properties, the modified filler has the benefit of requiring less time and energy to get incorporated into the polymeric composition.

In one or more embodiments, the chemically-treated inorganic oxide may be produced by any method that results in such a filler, i.e., an inorganic oxide, having a carbon content of greater than 1 weight percent, in other embodiments, at least 1.5 weight percent, and in other embodiments, at least 2.0 weight percent; a sulfur content of greater than 0.1 weight percent, in other embodiments, at least 0.3 weight percent, and in other embodiments, at least 0.6 weight percent; a Silane Conversion Index, of at least 0.3, in other embodiments, at least 0.4, and in other embodiments, at least 0.5 and a Standard Tensile Stress @ 300% elongation of at least 7.0, in other embodiments, at least 7.5 and in other embodiments at least 8.0. In one or more embodiments, the chemically-treated inorganic oxide may also be characterized by a modified Brunauer-Emmett-Teller (BET), i.e., a single point surface area, of from 20 to 350 m²/g, in other embodiments from 40 to 300 m²/g and in other embodiments of from 100 to 200 m²/g, a pH of from 5 to 10, in other embodiments from 5.5 to 9.5, in other embodiments from 6.0 to 9.0 and in other embodiments, a pH of from 6.0 to 7.5 or the pH of the product may range between any combination of these values, inclusive of the recited ranges; and a Soxhlet Extractable percent carbon of less than 30 percent, in other embodiments less than 25 percent and vless than 20 percent, e.g., 15 percent.

In one or more embodiments, the inorganic oxide may include aluminosilicate, colloidal silica, precipitated silica or mixtures thereof. In particulat embodiments, precipitated silica is used. Various commercially available silicas may used, such as silicas commercially available from PPG Industries under the Hi-Sil trademark with designations 210, 243, etc; silicas available from Rhone-Poulenc, with, for example, designations of Z1165MP and Z165GR and silicas available from Degussa AG with, for example, designations VN2 and VN3, etc.

The BET surface area of the precipitated silica may generally be within a range of from 50 m²/g to 1000 m²/g, and in certain embodiments will be within a range of from 100 m²/g to 500 m²/g.

The precipitated silica may be in the form of an aqueous suspension from production stages that precede the drying step, such as a slurry formed during precipitation or as a reliquefied filter cake. The suspension can also be formed by re-dispersing dried silica into an aqueous and/or organic solvent. The concentration of hydrophilic precipitated silica in the aqueous and/or organic suspension is not critical and can be within a range of about 1 to 90 weight percent. In particular embodiments, the concentration of hydrophilic precipitated silica is within a range of from 1 to 50 weight percent, or within a range of from 1 to 20 weight percent.

In certain embodiments, the chemically-treated inorganic oxide may be prepared as disclosed in U.S. Pat. Nos. 5,908,660 and 5,919,298, respectively, which disclosures are incorporated herein by reference, with the following changes. The amount of acid used results in a pH of 2.5 or less in the aqueous suspension, in other embodiments, a pH of 2.0 or less, and in other embodiments, a pH of 1.0 or less and in other embodiments a pH of 0.5 or less; the modifying chemical used is a combination of bis(alkoxysilylalkyl)polysulfide and a non-sulfur containing organometallic compound, which is referred to hereinafter as non-sulfur organometallic compound, in a weight ratio of the bis(alkoxysilylalkyl)polysulfide to the non-sulfur organometallic compound of at least 0.05:1, in other embodiments from 0.05:1 to 10:1, in other embodiments from 0.1:1 to 5:1, and in other embodiments from 0.2:1 to 2:1, e.g., from 0.5:1 to 1:1, or the weight ratio may range between any combination of these values, inclusive of the recited values; and after the chemical treatment reaction is completed, the acidity (either added or generated in situ by the hydrolysis of halogenated organometallic compounds) is neutralized. Typically after completing the chemical treatment reaction, the pH of the resulting aqueous suspension is increased to a pH range of from 3 to 10. The neutralizing agents can be of any type typically used to increase the pH of an acidic solution as long as the properties of the modified filler are not adversely effected. Suitable neutralizing agents include sodium hydroxide, potassium hydroxide, ammonium hydroxide and sodium bicarbonate. Neutralization of the modified filler may also be accomplished by adding gaseous ammonia to the aqueous solution during spray drying.

The acid used in step (A) may be of many types, organic and/or inorganic. The preferred acid catalyst is inorganic. Examples of suitable acid catalysts include hydrochloric acid, hydrobromic acid, hydroiodic acid, sulfuric acid, nitric acid, phosphoric acid, and benzenesulfonic acid. One acid catalyst or a mixture of two or more acid catalysts may be employed as desired. When the organometallic reactant is, for example, a chlorosilane, the catalytic amount of the acid may be generated in situ by hydrolysis of the chlorosilane or the reaction of the chlorosilane directly with hydroxyls of the inorganic oxide.

The temperature at which step (A) is conducted is not critical and is usually within the range of from 20° C. to 250° C., although somewhat lesser or somewhat greater temperatures may be used when desired. The reaction temperature will depend on the reactants used, e.g., the organometallic compound(s), the acid and, if used, a co-solvent. In one or more embodiments, step (A) is conducted at temperatures in the range of from 30° C. to 150° C., although Step (A) can be conducted at the reflux temperature of the slurry used in step (A) when this is desired.

In the aforedescribed reaction, the modifying chemical or coupling agent may be a combination of functionalizing agent(s) in place of bis(alkoxysilylalkyl)polysulfide and hydrophobizing agent(s) in place of a non-sulfur organometallic compound. The combination of functionalizing and hydrophobizing agents may be used in the same weight ratios specified for the combination of bis(alkoxysilylalkyl)polysulfide to the non-sulfur organometallic compound. Examples of reactive groups that the functionalizing agent may contain include, but are not limited to vinyl, epoxy, glycidoxy and (meth)acryloxy. Sulfide, polysulfide and mercapto groups may also be the reactive groups of the functionalizing agent provided they are not associated with the reactants represented by chemical formulae I and VII, included herein. As the hydrophobizing agents, materials include but are not limited to chemicals such as natural or synthetic fats and oils and the non-sulfur organometallic compounds represented by chemical formulae II, III, IV, V and mixtures of such hydrophobizing agents.

### Additional Fillers

As suggested above, the vulcanizable compositions of the present invention may include additional fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

Some commercially available silicas which may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J.M. Huber Corp. (Edison, N.J.).

In one or more embodiments, silicas may be characterized by their surface areas, which give a measure of their reinforcing character. The Brunauer, Emmet and Teller (“BET”) method (described in J. Am, Chem. Soc., vol. 60, p. 309 et seq.) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

The pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be added to the rubber compositions during mixing in order to enhance the interaction of silica with the elastomers. Useful coupling agents and shielding agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172 5,696,197, 6,608,145, 6,667,362, 6,579,949, 6,590,017, 6,525,118, 6,342,552, and 6,683,135, which are incorporated herein by reference.

### Curative

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. Vulcanizing agents may be used alone or in combination.

### Other Ingredients

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils.

### Mixing Procedure

All ingredients of the rubber compositions can be mixed with standard mixing equipment such as Banbury or Brabender mixers, extruders, kneaders, and two-rolled mills. As suggested above, the ingredients are mixed in two or more stages. In the first stage (i.e., mixing stage), which typically includes the rubber component and filler, is prepared. To prevent premature vulcanization (also known as scorch), vulcanizing agents. Once the masterbatch is prepared, the vulcanizing agents may be introduced and mixed into the masterbatch in a final mixing stage, which is typically conducted at relatively low temperatures so as to reduce the chances of premature vulcanization. Additional mixing stages, sometimes called remills, can be employed between the masterbatch mixing stage and the final mixing stage.

### Preparation of Tire

The compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171, 5,876,527, 5,931,211, and 5,971,046, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

### Prophetic Example

Six vulcanizable rubber compositions are prepared according to the recipes proved in Table I below, wherein the numbers are expressed in parts by weight.

TABLE I

| | Samples | | | | | |
|---|---|---|---|---|---|---|
| Ingredients | 1 | 2 | 3 | 4 | 5 | 6 |

Masterbatch

| | | | | | | |
|---|---|---|---|---|---|---|
| SBR | 70 | 70 | 70 | 70 | 70 | 70 |
| NR | 30 | 30 | 30 | 30 | 30 | 30 |
| N234CB | 4 | 4 | 4 | 4 | 4 | 4 |
| Black Oil | 10 | 10 | 10 | 10 | 10 | 10 |
| Silica Filler | 55 | 55 | 55 | — | — | — |
| Chemically-treated | — | | | 55 | 55 | 55 |
| Silica | | | | | | |
| Silane | 5 | 5 | 5 | — | — | — |
| Wax | 2 | 2 | 2 | 2 | 2 | 2 |
| Stearic Acid | 2 | 2 | 2 | 2 | 2 | 2 |
| 6PPD | 0.95 | 0.95 | 0.95 | 0.95 | 0.95 | 0.95 |
| Cellulose Ester | — | 5 | — | — | 5 | — |

Remill

| | | | | | | |
|---|---|---|---|---|---|---|
| Cellulose Ester | — | — | 5 | — | — | 5 |

Final Mix

| | | | | | | |
|---|---|---|---|---|---|---|
| Sulfur | 1.5 | 1.5 | 1.5 | 1.5 | 1.5 | 1.5 |
| ZnO | 2.5 | 2.5 | 2.5 | 2.5 | 2.5 | 2.5 |
| MBTS | 0.5 | 0.5 | 0.5 | 0.5 | 0.5 | 0.5 |
| TBBS | 0.5 | 0.5 | 0.5 | 0.5 | 0.5 | 0.5 |
| DPG | 0.3 | 0.3 | 0.3 | 0.3 | 0.3 | 0.3 |

Analyses Fair = 1 Good = 2 Better = 3 Best = 4

| | | | | | | |
|---|---|---|---|---|---|---|
| tan δ | 2 | 1 | 3 | 2 | 4 | 4 |
| ΔG′ | 2 | 1 | 3 | 2 | 4 | 4 |

As shown in Table I, a two-step mixing procedure is employed for Samples 1, 2, 4, and 5 where the masterbatch is first prepared by mixing the ingredients within a pilot-scale Brabender mixer operating at 70 rpm at about 155° C. for about 4 minutes. Following preparation of this masterbatch, the mixture is dropped from the mixer, allowed to cool below 80° C., and then the mixture is reintroduced to the mixer together with the cure agents and coagents. Mixing is continued for about 3 minutes at 60 rpm at about 100° C.

In Samples 3 and 6, a third mix step (i.e., remill) is employed between the Masterbatch and a Final Mix, wherein cellulose ester is added after preparation of the initial masterbatch; mixing is continued for about 4 minutes at 70 rpm at about 155° C. Following this mixing, the composition is dropped from the mixer as described above, and then the curative is added and mixed as described above.

The silica is obtained under the tradename Hi Sil 190 G (PPG Industries) and is characterized by an N₂ surface area/BET-5 of 195, a pH of 7, an Na₂2SO₄ content of less than 0.5 weight percent, and a bulk density of about 18 lbs/ft³. The chemically-treated silica is obtained under the tradename Agilon 458 (PPH Industries) and is characterized by a CTAB surface area of 200 m²/g, a pH of 6.8, an SH content of 0.5 weight percent, a carbon content of 6.0 weight percent, and a bulk density of about 24 lbs/ft³. The cellulose ester is obtained under the tradename CAB-553-0.4 (Eastman Chemical) and is generally characterized by a hydroxyl content of 4.8, a melting point of 150-160° C., a Tg of about 136° C., an acetal content of about 2.0, a butyryl content of about 46, and a viscosity of 1.14 poise.

After preparation of each of the vulcanizable compositions, appropriate test specimens are prepared to conduct the various analyses set forth in Table I. Where the analyses take place on cured rubber samples, the samples are prepared by curing an appropriate green sample at 160° C. within a heated press for about 30 minutes. The data presented in Table I for each of the analyses has been normalized based upon a scale of fair, good, better, and best, with each designation indicating successively better results.

As can be seen from a review and comparison of Samples 1-3, the cellulose ester provides improved results so long as the cellulose ester is added after the initial msterbatch is prepared. Where the cellulose ester is added to the original masterbatch, as in Sample 2, deleterious results are obtained. On the other hand, as shown by a review of Samples 5 and 6, where the cellulose ester is employed in combination with a chemically-treated silica, advantageous results are obtained regardless of whether the cellulose ester is added directly to the masterbatch or added subsequently to the masterbatch through a remill.

The Mooney viscosity (ML₁₊₄) of the uncured rubber compound was determined at 130° C. by using an Alpha Technologies Mooney viscometer with a large rotor, a one-minute warm-up time, and a four-minute running time. The tensile mechanical properties (modulus, T_{b}, and E_{b}) of the vulcanizates were measured by using the standard procedure described in ASTM-D412. The hysteresis data (tanδ) and the Payne effect data (ΔG′) of the vulcanizates were obtained from a dynamic strain-sweep experiment, which was conducted at 50° C. and 15 Hz with strain sweeping from 0.1% to 20%. ΔG′ is the difference between G′ at 0.1% strain and G′ at 20% strain.

Various modifications and alterations that do not depart from the scope and spirit of this invention will become apparent to those skilled in the art. This invention is not to be duly limited to the illustrative embodiments set forth herein.

What is claimed is:

1. A process for preparing a vulcanizable composition, the process comprising:
i. mixing a vulcanizable rubber, a chemically-treated inorganic oxide, and a cellulose ester to prepare an initial masterbatch;
ii. introducing a rubber curative to the masterbatch; and
iii. mixing the masterbatch and curative to form the vulcanizable composition.

2. The process of claim 1, where said step of mixing a vulcanizable rubber, a chemically-treated inorganic oxide, and a cellulose ester takes place at a temperature of at least 140° C.

3. The process of claim 2, where said step of mixing the masterbatch and the curative takes place at a temperature of at most 110° C.

4. The process of claim 3, where said step of introducing a rubber curative to the masterbatch takes place while the temperature of the masterbatch is at most 100° C.

5. The process of claim 1, where the chemically-treated inorganic oxide is characterized by a carbon content of greater than 1 weight percent and a mercapto content of greater than 0.1 weight percent.

6. The process of claim 5, where the chemically-treated inorganic oxide is characterized by a carbon content of greater than 2 weight percent and a mercapto content of greater than 0.2 weight percent.

7. The process of claim 6, where the chemically-treated inorganic oxide is characterized by a carbon content of greater than 3 weight percent and a mercapto content of greater than 0.3 weight percent.

8. The process of claim 1, where the chemically-treated inorganic oxide is a chemically-treated silica.

9. The process of claim 1, where said step of mixing a vulcanizable rubber, a chemically-treated inorganic oxide, and a cellulose ester produces a masterbatch including from about 1 to about 90 parts by weight chemically-treated inorganic oxide per 100 parts by weight rubber, and from about 1 to about 15 parts by weight cellulose ester per 100 parts by weight rubber.

10. A rubber vulcanizate prepared by:
i. mixing a vulcanizable rubber, a chemically-treated inorganic oxide, and a cellulose ester to prepare an initial masterbatch;
ii. introducing a rubber curative to the masterbatch; and
iii. mixing the masterbatch and curative to form the vulcanizable composition.

11. The process of claim 10, where the vulcanizate is a tire component.

12. The process of claim 11, where the tire component is a tire tread.

13. The process of claim 10, where said step of mixing a vulcanizable rubber, a chemically-treated inorganic oxide, and a cellulose ester takes place at a temperature of at least 140° C., and where said step of mixing the masterbatch and the curative takes place at a temperature of at most 110° C.

14. The process of claim 13, where said step of introducing a rubber curative to the masterbatch takes place while the temperature of the masterbatch is at most 100° C.

15. The process of claim 10, where the chemically-treated inorganic oxide is characterized by a carbon content of greater than 1 weight percent and a mercapto content of greater than 0.1 weight percent.

16. The process of claim 10, where the chemically-treated inorganic oxide is a chemically-treated silica.

17. The process of claim 10, where said step of mixing a vulcanizable rubber, a chemically-treated inorganic oxide, and a cellulose ester produces a masterbatch including from about 1 to about 90 parts by weight chemically-treated inorganic oxide per 100 parts by weight rubber, and from about 1 to about 15 parts by weight cellulose ester per 100 parts by weight rubber.
